(19) United States
(12) Patent Application Publication
(10) Pub. No.: US 2018/0100256 A1
(43) Pub. Date: Apr. 12, 2018

(54) HIGH PERFORMANCE FLAME BARRIERS

(71) Applicants: ZOLTEK COMPANIES, INC., St. Louis, MO (US); ACHILLE BAYART & CIE S.A.S., Roubaix (FR)

(72) Inventors: Alan Carl HANDERMANN, St. Louis, MO (US); Sebastien PAILLET, Wasquehal (FR)

(21) Appl. No.: 15/730,910

(22) Filed: Oct. 12, 2017

Related U.S. Application Data
(60) Provisional application No. 62/407,158, filed on Oct. 12, 2016.

(51) Int. Cl. D04H 1/43; B32B 5/02; B32B 5/06; B32B 5/08; B32B 29/02; B32B 27/12; B32B 15/14; D04H 1/4218; D04H 1/46

(52) U.S. Cl. CPC D04H 1/43; B32B 5/022; B32B 5/06; B32B 5/08; B32B 29/02; B32B 27/12; B32B 2607/00; D04H 1/4218; D04H 1/46; D10B 2101/06; D10B 2321/10; B32B 2307/3065; B32B 2419/06; B32B 15/14

(57) ABSTRACT

A nonwoven flame barrier useful in applications requiring a high performance low cost flame barriers that can protect against elevated flame temperatures for extended time periods includes an intimate blend of virgin oxidized polyacrylonitrile fibers; regenerated oxidized polyacrylonitrile fibers; and silica fibers or silica-loaded fibers.

This application claims priority of U.S. Provisional Patent Application No. 62/407,158 filed Oct. 12, 2016, which is hereby incorporated herein by reference.

### TECHNICAL FIELD

The present invention is directed to nonwoven flame barriers that are particularly useful in applications requiring a high performance low cost flame barriers that can protect against elevated flame temperatures for extended time periods. Such applications include, for example, fuel lines, combustible liquid process pipelines and valves, structural steel fireproofing, electrical cable wrap, ASTM E-108 Class A rated roofing and fire-rated wall assemblies, especially those requiring two, three and four hour fire-ratings, when tested according to ASTM E-119 or similar testing methods and standards.

### BACKGROUND

Fire-rated roofing and wall assemblies are commonly used in the building construction industry. Such assemblies are aimed at preventing fire, heat, and smoke from traveling from one section of a building to another. These assemblies often incorporate the use of a fire-retardant materials that substantially block the path of the fire, heat, and smoke for at least some period of time. The fire-retardant material may include fibers or fibrous fabrics; however, they are typically rigid and board-like and require a labor intensive installation process.

Conventional flame barriers, for these applications, can include organic or resinous binders to adhere intumescent and/or endothermic materials to a fibrous substrate, which also makes the flame barrier rigid and board-like. Another disadvantage of organic binders or resins is that these materials often burn and generate smoke and noxious gases when exposed to direct flame. Furthermore, these types of conventional flame barriers are difficult and expensive to install.

Commercially available roofing and wall assemblies include those made of stressed skin sandwich panels that include steel, aluminum or fiberglass reinforced polyester facings, bonded to a volcanic rock mineral fiber with a heat polymerizing adhesive or wooden deck surfaces. Such insulating panels can often be extremely thick (e.g., 16 inches for some wall types) in order to achieve a three hour fire rating.

Other commercially available roofing and wall assemblies include insulation boards made of mineral wool insulation. To achieve a three hour fire wall rating, a 4 inch thick layer of this insulation board must be compressed to fit within a 3.5 inch steel stud cavity, which requires a very labor and material intensive installation process. Moreover, working with mineral wool insulation may cause worker irritation, it is rigid and board-like and may have potentially negative health effects upon inhalation.

### SUMMARY

The present invention is directed to a nonwoven flame barrier that is particularly useful in applications that require a high performance cost effective flame barrier where flame protection for extended time periods is desired. Such applications include, for example, fuel lines, combustible liquid process pipelines and valves, structural steel fireproofing, electrical cable wrap, ASTM E-108 Class A rated roofing and fire-rated wall assemblies, especially those requiring two, three and four hour fire-ratings, when tested according to ASTM E-119 or similar testing methods and standards.

In one preferred embodiment, the nonwoven flame barrier includes an intimate blend of virgin oxidized polyacrylonitrile fibers (VOPF), for example, those sold under the trade name Zoltek OX by Zoltek Corporation; mechanically regenerated oxidized polyacrylonitrile fibers (ROPF), for example, those sold by Achille Bayart & CIE; and silica or silica-loaded fibers.

In another embodiment, the nonwoven flame barrier may also include flame resistant fibers of a second type other than oxidized polyacrylonitrile fibers. The second type of flame resistant fibers may be chosen from among both virgin and regenerated versions of meta-aramids, para-aramids, poly(diphenylether para-aramid), polybenzimidazole, polyimides, polyamideimides, novoloids, poly(p-phenylene benzobisoxazoles), poly(p-phenylene benzothiazoles), flame retardant viscose rayon, polyetheretherketones, polyketones, polyetherimides, and combinations thereof.

In another embodiment, the nonwoven flame barrier further includes other inorganic high temperature reinforcing fibers chosen from among glass fiber, ceramic fiber, mineral fiber, carbon fiber, stainless steel fiber and combinations thereof.

In another embodiment, the nonwoven flame barrier includes a reinforcing fiberglass mat layer.

In another embodiment, the nonwoven flame barrier further includes an outer laminar material. The outer laminar material may be a polymeric film, for example, a polymeric film chosen from among polyesters, polyethylenes, polypropylenes, polyvinyl chlorides, polyvinyl alcohols and combinations thereof.

In another embodiment, the outer laminar material may include a metal foil or paper material which may be mechanically, chemically or thermally bonded to the nonwoven flame barrier.

### DETAILED DESCRIPTION

The present invention provides a nonwoven flame barrier which, when tested according to standard flame resistance test methods such as American Standard Testing Method E-108 or E-119, allows for longer fire-rated roofing product or wall assembly and less installation labor time and materials to form thinner fire-rated roofing and wall assemblies. The nonwoven flame barrier provides a strong fire resistant layer and also slows down the transmission of heat.

Since the nonwoven flame barrier of the present invention is very flexible and lightweight, it is easily handled and installed in construction projects that require fire-rated roofing or wall assemblies. This provides more architectural design freedom by allowing thinner, lighter weight and easier to form roofing and wall assemblies to be constructed, while still meeting the fire-rated test requirements of the installation. In accordance with an embodiment of the present invention, there is provided a nonwoven flame barrier that includes at a single layer of nonwoven flame resistant fibers.

Preferably, the flame resistant fibers of the nonwoven fabric consists of an intimate blend of virgin oxidized polyacrylonitrile fiber (VOPF), mechanically regenerated oxidized polyacrylonitrile fiber (ROPF) flame resistant fibers and silica fibers, containing of 85-97% SiO₂, 3-15% Al₂O₃ and 1-5% other (by weight); or an intimate blend of virgin oxidized polyacrylonitrile fibers (VOPF), mechanically regenerated oxidized polyacrylonitrile (ROPF) flame resistant fibers and a silica loaded viscose fiber, e.g., fibers containing 25-50% silica.

Surprisingly, it has been found that by making an intimate blend of virgin oxidized polyacrylonitrile fibers (VOPF), mechanically regenerated oxidized polyacrylonitrile fibers (ROPF) and silica fibers, the thermal cooling efficiency and extended protection time of the flame barrier of the invention is substantially better than a comparable flame barrier made with an intimate blend of virgin oxidized polyacrylonitrile fibers (VOPF) and mechanically regenerated oxidized polyacrylonitrile (ROPF) flame resistant fibers. The inclusion of regenerated oxidized polyacrylonitrile fibers also substantially reduces the cost of making such a flame barrier, allowing it to be used in cost sensitive end use applications such as building construction applications.

### Nonwoven Textile Layer

In one embodiment, the nonwoven flame barrier is made by mechanically entangling the blended fibers via a needlepunching process.

In another embodiment, one or more flame resistant fibers of a second type other than oxidized polyacrylonitrile fibers may be included in the nonwoven flame barrier. Examples of such second type of flame resistant fibers that can be incorporated into the nonwoven textile layer include meta-aramids such as poly(m-phenylene isophthalamide), for example, those sold under the trade name NOMEX® by E. I. Du Pont de Nemours and Co., TEIJINCONEX by Teijin Limited, ARAMID 1313 by Guangdong Charming Chemical Co. Ltd., etc.; para-aramids such as poly(p-phenylene terephthalamide), for example, that are sold under the trade name KEVLAR® by E. I. Du Pont de Nemours and Co., poly(diphenylether para-aramid), for example, that are sold under the trade name TECHNORA by Teijin Limited, and those sold under the trade name TWARON by Teijin Limited, etc.; polybenzimidazole such as that sold under the trade name PBI by PBI Performance Products, Inc.; polyimides, for example, those sold under the trade names P-84 by Evonik Industries; polyamideimides, for example, that are sold under the trade name KERMEL® by Kermel; novoloids, for example, phenol-formaldehyde novolac, that are sold under the trade name KYNOL® by Gun Ei Chemical Industry Co.; poly (p-phenylene benzobisoxazole) (PBO), for example, that are sold under the trade name ZYLON® by Toyobo Co.; poly (p-phenylene benzothiazoles) (PBT); polyphenylene sulfide (PPS), for example, those sold under the trade names RYTON® by Chevron Phillips Chemical Company LLC, TORAY PPS by Toray Industries Inc., FORTRON® by Kureha Chemical Industry Co. and PROCON by Toyobo Co.; flame retardant viscose rayons, for example, those sold under the trade names LENZING FR by Lenzing A.G.; polyetheretherketones (PEEK), for example, that are sold under the trade name ZYEX by Zyex Ltd.; polyketones (PEK); polyetherimides (PEI), for example, that are sold under the trade name ULTEM® by Fiber Innovation Technologies Inc., and fiber combinations thereof.

### Additional Layers

In another embodiment, a reinforcing layer consisting of a nonwoven fiberglass mat is mechanical bonded between two layers of the intimately blended nonwoven felt or to one of the nonwoven surface layers. The reinforcing layer may also be a woven fabric scrim. The reinforcing layer can consist of a high temperature reinforcement material constructed of glass; ceramic; carbon; mineral, such as basalt; metal, such as stainless steel; flame resistant polymers, such those listed above; and combinations of two or more thereof. In one embodiment, the reinforcing layer is a fiberglass scrim.

Nonwoven flame barrier may include an outer laminar layer. The laminar layer may be a coated paper, a polymeric film, or a metallic foil. Examples of useful polymeric films include polyesters, polyethylenes, polypropylenes, polyvinyl chlorides, polyvinyl alcohols and combinations thereof. A laminar layer may be bonded to the outer surface of one or both of nonwoven textile layers, for example, by lamination.

The needlepunching process causes many individual fibers of the nonwoven textile layers to extend through the reinforcing layer and to anchor into the substrate layer below. Fibers extending from the top nonwoven textile layer and anchoring into the bottom nonwoven textile layer form strong mechanical bonds between the layers, interlocking fibers between the nonwoven layers.

After the needlepunching process, a roll of the final assembled product is collected at the exit of the needling loom.

In another process embodiment, it is possible to use a needling operation where needles enter the fabric from both the top and the bottom major surfaces. In this embodiment, the needling is performed from top to bottom and from bottom to top, either simultaneously or in separate stages of the needling process.

The following non-limiting examples are set forth to demonstrate the present invention.

### EXAMPLES

### Nonwoven Flame Barriers

Two high performance low cost flame barriers, of the invention, were made by needlepunching nonwoven felts consisting of an intimate fiber blend of virgin oxidized polyacrylonitrile fiber (VOPF), mechanically regenerated oxidized polyacrylonitrile fiber (ROPF) and silica fibers and were compared to nonwoven needlepunched felts that did not contain the silica fibers (see Table 1).

TABLE 1

| | Total | | | |
|---|---|---|---|---|
| | Areal | | | |
| FR Barrier | Weight | | | |
| Example # | (gsm) | Layer 1 | Layer 2 | Layer 3 |
| 1 | 360 | 360 gsm 25% VOPF/ | | |
| | | 25% ROPF/50% | | |
| | | silica fiber blend | | |
| 2 | 395 | 200 gsm 25% VOPF/ | 45 gsm glass | 150 gsm |
| | | 25% ROPF/50% | mat | 50% VOPF/ |
| | | silica fiber blend | | 50%/ |
| | | | | ROPF |
| Comparative | 345 | 300 gsm 100% | 45 gsm glass | |
| A | | ROPF | mat | |
| Comparative | 645 | 600 gsm 100% | 45 gsm glass | |
| B | | ROPF | mat | |
| Comparative | 645 | 300 gsm 50% VOPF/ | 45 gsm glass | 300 gsm |
| C | | 50% ROPF | mat | 50% VOPF/ |
| | | | | 50% |
| | | | | ROPF |

### Flame Barrier Test

The flame barriers listed in Table 1 were tested according to a procedure as described below.

A wooden plywood test deck is set at a 30° angle and an 8.5″×11″ piece of nonwoven flame barrier is fixed to the test deck. Three temperature sensors are located as follows:
Sensor #1—Top surface of the FR barrier, at the flame point.
Sensor #2—Between the FR barrier and test deck, at the flame point.
Sensor #3—Under the test deck, at the flame point.

A propane torch is directed toward the center of the nonwoven flame barrier, place 1″ from the surface of the barrier. A controlled temperature profile is maintained at Sensor #1, as follows:

| | |
|---|---|
| 900° C. | 0-32 minutes |
| 800° C. | 32-40 minutes |
| 750° C. | 40-50 minutes |
| 650° C. | 50-60 minutes |

Temperature is recorded at all three sensors every minute, for 60 minutes, or until the nonwoven flame barrier fails by burning through.

The time Sensor #2 (between the barrier and the wooden deck) reaches 300° C. is recorded; as this is the point where burning fumes first appear from the wooden deck.

The time Sensor #3 (under the wooden deck) reaches the maximum temperature is recorded. The temperature at Sensor #3 (under the wooden deck) at the end of the 60 minute test and temperature ramp rate at the 60 minute mark is also recorded. A lower temperature and a decreasing temperature ramp rate demonstrates a high performance barrier of the invention. Barrier failure is considered to be when the barrier burns through or when the temperature under the test deck continues to increase, after the 60 minute test time.

Results of the flame test are shown in Table 2.

TABLE 2

| | | | Temp. after | Time Max. | |
|---|---|---|---|---|---|
| | Sensor #2 | Max. Temp. | 60 min. @ | Temp. | Temp. Ramp |
| FR Barrier | reaches | @ Sensor | Sensor #3, | Observed @ | Rate at Sensor |
| Example # | 300° C., min | #3, ° C. | ° C. | Sensor #3, min | #3 after 60 min. |
| 1 | 25 | 93 | 78 | 43 | Temp. |
| | | | | | decreasing after |
| | | | | | 60 min |
| 2 | 9 | 125 | 96 | 41 | Temp. |
| | | | | | decreasing after |
| | | | | | 60 min |
| Comparative | <1 | Barrier Burns | Failure | Barrier Fails | Barrier Failed |
| A | | Through | | @ 17 min | |
| | | @ 17 min | | | |
| Comparative | 3 | Barrier Burns | Failure | Barrier Fails | Barrier Failed |
| B | | Through | | @ 33 min | |
| | | @ 33 min | | | |
| Comparative | 27 | 146 | 146 | >60 | Temp. still |
| C | | | | | increasing after |
| | | | | | 60 min (failure) |

Example 1 demonstrates that a one-layer, 360 gsm needlepunched fiber blend of 25% virgin OPF, 25% regenerated OPF and 50% silica fibers performs much better than a 645 gsm barrier of 100% regenerated OPF needled to a 45 gsm glass mat (Comparative Example B), which failed this test. Even when a 45 gsm glass mat is inserted between two 300 gsm layers of a 50% virgin OPF, 50% regenerated OPF blend (Comparative Example C); it perform significantly worse than the much lighter weight one layer felt of the present invention (Example 1).

Although the contemplated use of the high performance low cost nonwoven flame barrier of the present invention includes applications such as fuel lines, combustible liquid process pipelines and valves, structural steel fireproofing, electrical cable wrap, ASTM E-108 Class A rated roofing and fire-rated wall assemblies, it is to be understood that other end uses can also be considered. Other uses for the high performance flame barrier of the present invention may include, for example, fire protection for equipment shrouds, support members, electrical circuit panels, medical gas boxes and elevator call boxes.

While the invention has been explained in relation to various embodiments, it is to be understood that various modifications thereof will be apparent to those skilled in the art upon reading the specification. The features of the various embodiments of the articles described herein may be combined within an article. Therefore, it is to be understood that the invention described herein is intended to cover such modifications as fall within the scope of the appended claims.

1. A nonwoven flame barrier comprising an intimate blend of virgin oxidized polyacrylonitrile fibers; regenerated oxidized polyacrylonitrile fibers; and
silica fibers.

2. A nonwoven flame barrier comprising an intimate blend of virgin oxidized polyacrylonitrile fibers; regenerated oxidized polyacrylonitrile fibers; and silica-loaded fibers.

3. A nonwoven flame barrier of claim 1, wherein the barrier further comprises flame resistant fibers of a second type other than oxidized polyacrylonitrile fibers.

4. A nonwoven flame barrier of claim 3, wherein the second type of flame resistant fibers is chosen from among virgin or regenerated versions of meta-aramids, para-aramids, poly(diphenylether para-aramid), polybenzimidazole, polyimides, polyamideimides, novoloids, poly(p-phenylene benzobisoxazoles), poly(p-phenylene benzothiazoles), flame retardant viscose rayon, polyetheretherketones, polyketones, polyetherimides, and combinations thereof.

5. A nonwoven flame barrier of claim 1, wherein the barrier further comprises non-flame resistant fibers.

6. A nonwoven flame barrier of claim 1, wherein the barrier further comprises high temperature reinforcing fibers chosen from among glass fiber, ceramic fiber, mineral fiber, carbon fiber, stainless steel fiber and combinations thereof.

7. A nonwoven flame barrier of claim 1, further comprising a reinforcing layer of a fiberglass mat or fiberglass scrim.

8. A nonwoven flame barrier of claim 1, further comprising an outer laminar material.

9. A nonwoven flame barrier of claim 8, wherein the outer laminar material comprises a polymeric film.

10. A nonwoven flame barrier of claim 9, wherein the polymeric film is chosen from among polyesters, polyethylenes, polypropylenes, polyvinyl chlorides, polyvinyl alcohols and combinations thereof.

11. A nonwoven flame barrier of claim 8, wherein the outer laminar material comprises metal foil.

12. A nonwoven flame barrier of claim 8, wherein the outer laminar material comprises paper.

13. The composite of claim 1, wherein the nonwoven flame barrier is mechanically bonded by needlepunching, quilting or stitch bonding.

14. The nonwoven flame barrier of claim 1 that provides for a roofing assembly with a Class A fire rating when tested according to ASTM E-108.

15. The nonwoven flame barrier of claim 1 that provides for a wall assembly with a fire rating of 1 hr, 1.5 hr, 2 hr, 2.5 hr, 3 hr and 4 hr when tested according to ASTM E-119.

16. A gypsum wallboard installation comprising the nonwoven flame barrier of claim 1.
